(19) United States
(12) Patent Application Publication
(10) Pub. No.: US 2008/0278376 A1
(43) Pub. Date: Nov. 13, 2008

(54) METHOD AND APPARATUS FOR BEAM STEERING ARRAY ANTENNA WITH MODIFIED RADIATING PATCHES

(76) Inventor: Choon Sae Lee, Dallas, TX (US)

Correspondence Address: CARR LLP, 670 FOUNDERS SQUARE, 900 JACKSON STREET, DALLAS, TX, 75202, US

(21) Appl. No.: 11/745,330

(22) Filed: May 7, 2007

(51) Int. Cl. H01Q 1/38

(52) U.S. Cl. 343/700 MS

(57) ABSTRACT

An antenna provides a first radiating element in an array of radiating elements. The first radiating element is configured to receive a first standing wave power from a first feed line and to receive a second standing wave power from a second feed line. The first feed line is approximately orthogonal to the second feed line. The radiating element is further configured to reject at least one polarization. A phase shifter is coupled to the first radiating element.

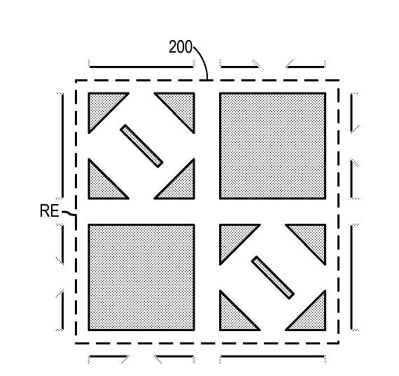

### RELATED APPLICATION

This patent application incorporates herein by reference co-pending and commonly assigned U.S. patent application entitled “Method and Apparatus for Beam Steering Array Antenna” by Choon Sae Lee, filed May 15, 2004, Ser. No. 10/846,280 in its entirety for all purposes, and co-pending and commonly assigned U.S. patent application entitled “Microstrip Array Antenna” by Choon Sae Lee, filed Oct. 23, 2002, Ser. No. 10/278,252 in its entirety for all purposes.

### DESCRIPTION

In addition to the features disclosed by U.S. patent application Ser. No. 10/846,280 and U.S. patent application Ser. No. 10/278,252, the radiating elements of a beam steering array antenna may comprise modified radiating patches. Accordingly, when the vertical and horizontal feed lines provide specific phases at each element for horizontal and vertical electric components, respectively, of the radiated fields, the resultant radiated fields can be decomposed into two orthogonal components: right-handed circular polarization (RHCP) and left-handed circular polarization (LHCP).

Each of the radiated fields will have an average phase of those vertical and horizontal inputs. Therefore the beam will be steered in the direction for which each element radiates with an average phase of the two inputs, assuming the magnitudes are the same. When the radiating elements are square patches without any modification, one of the two polarizations is a cross polarization. The patches can be modified to accommodate a particular polarization, for example by using a rectangular slot at the center of each patch. When the patch rejects the other type of polarization, the mode will be reflected to the feed transmission line and contribute in formation of a standing wave in the antenna cavity. In such a case, the cross-polarization level will be relatively low and the beam can be steered in two-dimensional direction with only two phase inputs.

1. An antenna comprising:
a plurality of radiating elements formed in an array of M sets of radiating elements in a first direction and N sets of radiating elements in a second direction;
a plurality of M feed lines, each of the M feed lines configured to supply a standing wave to at least one radiating element in a respective one of the M sets of radiating elements;
a plurality of N feed lines, each of the N feed lines configured to supply a standing wave to at least one radiating element in a respective one of the N sets of radiating elements; and
a phase shifter coupled to at least one of the M feed lines, wherein at least one of the radiating elements is configured to reject a first polarization.

2. A method of steering a beam, the method comprising:
supplying an array of radiating elements with a standing wave on each of a plurality of M feed lines and N feed lines, wherein at least one radiating element in the array is configured to reject a first polarization; and
phase shifting at least one of the standing waves.

3. An antenna comprising:
a first radiating element in an array of radiating elements, wherein the first radiating element is configured to receive a first standing wave power from a first feed line and to receive a second standing wave power from a second feed line, wherein the first feed line is approximately orthogonal to the second feed line, and wherein the radiating element is further configured to reject at least one polarization; and
a phase shifter coupled to the first radiating element.
